(19) United States
(12) Patent Application Publication
(10) Pub. No.: US 2024/0280543 A1
(43) Pub. Date: Aug. 22, 2024

(54) WATER WALL BOILER TUBE GUIDED WAVE SENSOR

(71) Applicant: FBS, Inc., Bellefonte, PA (US)

(72) Inventors: Cody J. Borigo, Palmyra, PA (US); Steven E. Owens, State College, PA (US); Kyle David Himes, Tyrone, PA (US)

(73) Assignee: FBS, Inc., Bellefonte, PA (US)

(21) Appl. No.: 18/441,370

(22) Filed: Feb. 14, 2024

Related U.S. Application Data
(60) Provisional application No. 63/486,288, filed on Feb. 22, 2023.

(51) Int. Cl. G01N 29/24; G01N 29/04

(52) U.S. Cl. CPC G01N 29/2412; G01N 29/04; G01N 2291/023; G01N 2291/101; G01N 2291/2634

(57) ABSTRACT

In some embodiments, a system for non-destructively testing an object may include a probe. The probe may include a body including a shoe, at least one magnetostrictive sensor assembly supported by the shoe, at least one coupling device of a first type supported by the body, and at least one coupling device of a second type supported by the body. The at least one coupling device of the first type may be configured to provide a first force for coupling the probe to the object. The at least one coupling device of a second type may be configured to provide a second force for coupling the at least one magnetostrictive sensor assembly to the object. In some embodiments, the system may include a pulser/receiver unit configured to be communicatively coupled to the at least one magnetostrictive sensor assembly.

### CROSS-REFERENCE TO RELATED APPLICATIONS

This application claims priority to U.S. Provisional Patent Application No. 63/486,288, filed Feb. 22, 2023, the entirety of which is incorporated by reference herein.

### FIELD

This disclosure relates to the non-destructive inspection of sections of pipes, tubes, cylinders, and cylindrical vessels using ultrasonic guided waves.

### BACKGROUND

Ultrasonic guided wave techniques are utilized in a wide range of non-destructive inspection applications including those for pipes, plates, and shells comprised of metals, composites, and other materials. Guided waves are elastic waves propagating in a bounded structure that is utilized as a waveguide to transmit efficiently one or more wave modes along the structure. One of the foremost benefits of guided waves over other non-destructive inspection techniques is the ability of said waves to propagate over long distances, in many cases, hundreds of feet, and to inspect inaccessible or hidden structures from a single probe position.

Guided waves are formed from the constructive interference of ultrasonic bulk waves that have interacted with the boundaries of the structure in which they propagate. Guided waves are unique in the sense that they are capable of propagating for longer distances compared to traditional ultrasonic waves and can be used to inspect hidden/inaccessible structures like buried or cased piping and tubing. Unlike “spot-checking” with traditional ultrasonic techniques, guided waves provide a 100% volumetric inspection. Furthermore, guided waves provide an efficient and cost-effective means of inspection due to increased inspection speed and simplicity.

Magnetostrictive guided wave sensor systems have been disclosed in U.S. Pat. Nos. 11,519,878, 11,460,441, 10,119,942, 8,907,665, 6,917,196, and 7,852,073, all of which are incorporated by reference herein in their entireties.

### SUMMARY

A technology for dry coupling an ultrasonic guided wave magnetostrictive sensor for nondestructive detection of flaws in a structure. Specifically, the disclosed systems and methods facilitate coupling a ferromagnetic strip to a tube with limited access to the full circumference such as in the case of water wall boiler tubes using magnetic retention and mechanical pressure coupling during at least one of guided wave excitation and guided wave detection.

In some embodiments, a magnetostrictive dry-coupling system for pipes, tubes, cylinders, and cylindrical vessels may include at least one ferromagnetic strip, at least one sensor coil, at least one biasing magnet, a pneumatic coupling pressure mechanism, at least one retention magnet, a means for generating guided wave energy pulse via said sensor coil, a means for detecting reflected guided wave energy via said sensor coil, and a processor. The at least one ferromagnetic strip may be configured to be temporarily coupled to said structure by means of mechanical pressure coupling applied to the ferromagnetic strip. The at least one biasing magnet, which may be a permanent magnet or an electromagnet, is configured to apply a biasing magnetization to the at least one ferromagnetic strip. The at least one retention magnet, which may be a permanent magnet or an electromagnet, may be configured to counteract the force generated by the coupling pressure. The processor may be configured to record guided wave reflections via the sensor coil and process the guided wave data to identify the presence and location of anomalies in said structure.

In some embodiments, a system may include a probe and a pulser/receiver unit. The probe may include a shoe configured to be coupled to an object to be tested, at least one retention magnet supported by a body of the probe and configured to couple the probe to the object, and at least one magnetostrictive sensor assembly supported by the shoe of the probe. The pulser/receiver unit may be configured to be coupled communicatively to the at least one magnetostrictive sensor assembly. The pulser/receiver unit may be configured to cause at least one ultrasonic guided wave into the object via the at least one magnetostrictive sensor assembly and to receive a reflection of the at least one ultrasonic guided wave via the at least one magnetostrictive sensor assembly.

In some embodiments, the at least one retention magnet may include a permanent-switchable type magnet.

In some embodiments, the probe may include at least one switch knob coupled to the at least one retention magnet for selectively engaging the at least one retention magnet.

In some embodiments, the shoe may include a mechanical pressure coupling configured to couple the at least one magnetostrictive sensor assembly to the surface of the object.

In some embodiments, the magnetic pressure coupling may include a chamber defined by the shoe configured to be pneumatically pressurized.

In some embodiments, an elastomeric pressure diaphragm may be at least partially disposed within the chamber defined by the shoe. In some embodiments, the elastomeric pressure diaphragm may be disposed entirely within the chamber defined by the shoe.

In some embodiments, the probe may include at least one pressure relief valve configured to prevent pressurization of the chamber and/or the elastomeric pressure diaphragm.

In some embodiments, a surface of the at least one retention magnet may be curved to facilitate coupling of the probe to a curved surface of the object.

In some embodiments, a system for non-destructively testing an object may include a probe. The probe may include a body including a shoe, at least one magnetostrictive sensor assembly supported by the shoe, at least one coupling device of a first type supported by the body, and at least one coupling device of a second type supported by the body. The at least one coupling device of the first type may be configured to provide a first force for coupling the probe to the object. The at least one coupling device of a second type may be configured to provide a second force for coupling the at least one magnetostrictive sensor assembly to the object.

In some embodiments, the at least one coupling device of the first type may include a magnet supported by the body of the probe.

In some embodiments, the at least one coupling device of the second type may include an elastomeric pressure diaphragm that may be at least partially disposed within a chamber defined by the shoe. In some embodiments, the elastomeric pressure diaphragm may be disposed entirely within the chamber defined by the shoe.

In some embodiments, the probe may include at least one pressure relief valve configured to prevent pressurization of the elastomeric pressure diaphragm. In some embodiments, preventing pressurization of the elastomeric pressure diaphragm prevents pressurization of the chamber.

In some embodiments, the elastomeric pressure diaphragm may be disposed within the chamber defined by the shoe. The chamber may be at least partially or entirely sealed with a coupling layer.

In some embodiments, the at least one magnetostrictive sensor assembly may be disposed between the elastomeric pressure diaphragm and the coupling layer.

In some embodiments, the at least one magnetostrictive sensor assembly may include a strip of ferromagnetic material and at least one sensor coil. The strip of ferromagnetic material may be disposed adjacent to the coupling layer.

In some embodiments, the strip of ferromagnetic material may be disposed directly adjacent to the coupling layer.

In some embodiments, the at least one sensor coil may be disposed between the elastomeric pressure diaphragm and the strip of ferromagnetic material.

In some embodiments, the coupling layer may be curved.

In some embodiments, an outer jacket may be coupled to the shoe and at least partially overlap the coupling layer.

In some embodiments, the at least one coupling device of the first type may include a first magnet and a second magnet. The first magnet may be disposed on a first side of a handle of the body of the probe. The second magnet may be disposed on a second side of the handle of the body of the probe. The second side of the handle may be an opposite side of the handle with respect to the first side of the handle.

In some embodiments, the probe may include at least one switch knob for selectively providing the first force.

In some embodiments, the probe may include a first switch knob for selectively actuating the first magnet and a second switch knob for selectively actuating the second magnet. In some embodiments, a single switch knob may be provided for selectively actuating the first magnet and the second magnet.

In some embodiments, the at least one coupling device of the second type may include an elastomeric pressure diaphragm that is at least partially disposed within a chamber defined by the shoe.

In some embodiments, the system may include a pulser/receiver unit configured to be communicatively coupled to the at least one magnetostrictive sensor assembly, the pulser/receiver unit configured to cause at least one ultrasonic guided wave into the test object via the at least one magnetostrictive sensor assembly and to receive a reflection of the at least one ultrasonic guided wave via the at least one magnetostrictive sensor assembly.

### BRIEF DESCRIPTION OF THE FIGURES

FIG. 1 is an isometric view of one example of a probe configured on a water wall boiler tube in accordance with some embodiments;

FIG. 2A is an isometric view of one example of a water wall boiler tube in accordance with some embodiments;

FIG. 2B is a cross-sectional view of one example of a water wall boiler tube with internal corrosion in accordance with some embodiments;

FIG. 3A is an isometric view of one example of a probe in accordance with some embodiments;

FIG. 3B is a first side view of one example of a probe in accordance with some embodiments;

FIG. 3C is a second side view of one example of a probe in accordance with some embodiments;

FIG. 3D is a bottom view of one example of a probe in accordance with some embodiments illustrating the surfaces designed to be in contact with a tube;

FIG. 4 is an exploded view of one example of the components of a sensor shoe assembly in a probe in accordance with some embodiments;

FIG. 5 is an illustration of one example of the components of an inspection system in accordance with some embodiments;

FIG. 6A is a cross-sectional view of one example of a circuit board in accordance with some embodiments;

FIGS. 6B-6E illustrate examples of one example of coils formed in conductive layers of a circuit board in accordance with some embodiments;

FIG. 7 is an illustration of one example of the layers of a sensor assembly in accordance with some embodiments.

### DETAILED DESCRIPTION

This description of the exemplary embodiments is non-limiting and is intended to be read in connection with the accompanying drawings, which are to be considered part of the entire written description.

Guided wave inspection of pipes, plates, and tubes is a well-established practice in various industries, in which ultrasonic guided wave energy is generated in a structure and reflections from flaws such as corrosion or cracking are detected and interpreted to evaluate the health of said structure. Although most guided wave pipe inspection technologies require the sensor to be wrapped around the full circumference of the pipe or tube, the disclosed system does not suffer from this limitation and may be used on pipes and tubes for which physical access to the full circumference is limited.

One example of this is in the case of boiler water wall panels, which are a series of tubes aligned in parallel to one another and welded along a seam between each tube over all or some of its length. In many cases, a membrane bar is welded between said tubes. These water wall panels form the walls of the boiler's combustion chamber and typically carry water that evaporates into steam as it rises in the boiler. Corrosion of these water wall tubes is a significant problem as leaks can significantly reduce the efficiency of the system and can lead to contamination. Inspection of water wall membranes is a laborious process due, at least in part, to the large lengths of tubing present in a single boiler. It would not be uncommon for a water wall membrane to contain several hundred tubes, each of which can be 100 feet or more in length. Physical access to the tubes is a challenge and typically requires the construction of multiple scaffolding platforms to allow inspectors to directly access all portions of the tubes.

Guided wave inspection of these tubes would be advantageous because it would facilitate more rapid screening of the tubes from a limited number of inspection locations due to the ability of guided waves to propagate long distances in tubes. However, most guided wave pipe and tube inspection technologies require a sensor collar to be wrapped entirely around the circumference of said tubes, which is not possible in water wall membranes due to their construction. It would be advantageous to implement guided wave scans from one side of the water wall membrane, especially if the guided wave scanner does not require the use of couplant and can be attached, coupled, decoupled, and removed efficiently.

Various means of guided wave transduction exist including piezoelectric transducers, electromagnetic acoustic transducers (“EMATs”), impact devices, and magnetostrictive transducers. The disclosed system may use one or more of these types, including the magnetostrictive type.

In general, a magnetostrictive guided wave inspection system generates guided waves via the magnetostrictive effect, i.e. the Joule effect, by which a time-varying strain is induced in the ferromagnetic material by means of generating a time-varying current in a pulser coil in the presence of a biasing magnetic field that is perpendicular to the direction of wave propagation to generate shear-horizontal type waves, e.g. torsional waves in pipes, or parallel to the direction of wave propagation to generate Lamb-type waves, e.g. longitudinal waves in pipes. The coil traces may be oriented in a manner such that they induce a time-varying magnetic field in the ferromagnetic material that is parallel to the wave propagation direction and the axis of the pipe. By this process, guided waves may be generated in the structure to which the ferromagnetic material is coupled. The guided waves may propagate through the structure away from the pulser coil, and reflected wave energy from any structural anomalies subsequently may be detected by the scanner receiver via the inverse magnetostrictive effect, i.e., the Villari effect, in which the passing stress waves induce a time-varying magnetic field in the ferromagnetic strip, which induces a time-varying current in the receiver coil.

The biasing magnetization of the at least one ferromagnetic material may be achieved by swiping the ferromagnetic material with a permanent biasing magnet prior to use or by utilizing at least one permanent magnet, electromagnet, or electrical coil, as will be understood by those of ordinary skill in the art.

In general, ultrasonic shear coupling of a ferromagnetic strip to a structure may be achieved by means of at least one of shear couplant, bonding, brazing, adhesive taping, and mechanical pressure coupling such that shear stresses may be transferred from said strip to said structure and vice versa.

For the purposes of the description, the term “pipe” refers to hollow cylinders including, but not limited to, structures such as pipes, tubes, cylinders, and cylindrical vessels. For the purposes of the description, the term “shear horizontal guided waves” refers to the class of sonic/ultrasonic guided stress waves in flat and curved plates, which have predominantly in-plane displacement fields perpendicular to the wave propagation direction. The terms “Lamb wave” and “SH wave” can be strictly defined as these types of guided waves in homogenous, linear, isotropic plates having constant thickness. However, for the purposes of this disclosure, the terms “Lamb wave” and “SH wave” will be more broadly used to describe any of the Lamb-type and SH-type waves in plate-like structures that closely match the characteristics of the waves described by these strict definitions, including plates with a small degree of curvature and anisotropic plates. For the purposes of the description, the term “torsional guided waves” refers to the class of torsional sonic/ultrasonic guided stress waves in hollow cylinders, which have predominantly in-plane displacement fields perpendicular to the wave propagation direction. This term encompasses axisymmetric T(0, n) and non-axisymmetric, i.e. flexural, T(m≠0, n) modes in the torsional mode families of guided waves in hollow cylinders. For clarification, see Rose, J. L., Ultrasonic Guided Waves in Solid Media, Cambridge University Press, New York, NY, 2014, the entirety of which is incorporated by reference herein.

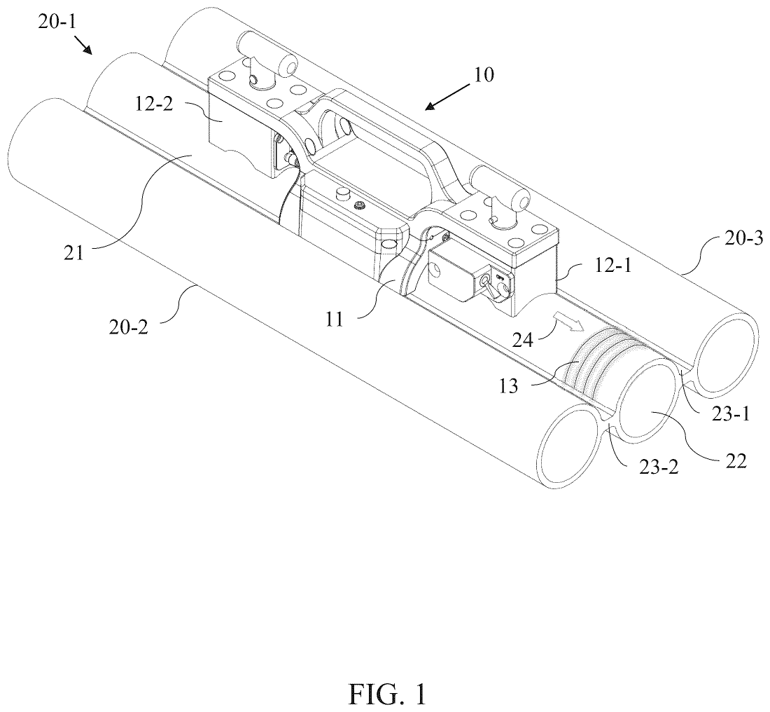

FIG. 1 illustrates one example of a guided wave probe 10 designed for coupling to tubes that may have limited access to a portion of their circumference. In the figure, probe 10 is coupled to a tube 20-1. Adjacent tubes 20-2, 20-3 are welded to tube 20-1 along seams 23-1, 23-2, which may include a membrane bar in some instances. The probe 10 may include a probe shoe 11, which may be designed to fit the curvature of the outer surface 21 of tube 20-1 without interfering with welds 23-1, 23-2 or the adjacent tubes 20-2, 20-3. Retention magnets 12-1 and 12-2 may be supported by the probe shoe 11 and may be configured to apply a magnetic force between probe 10 and tube 20-1. A guided wave 13 may be generated in the wall of tube 20-1 and propagated along its length in wave propagation direction 24. Reflected energy from the outgoing wave pulse 13 due to girth welds and flaws in tube 20-1 may be subsequently detected by probe 10 to detect their presence and determine their location. The disclosed system may be capable of detecting corrosion, cracking, and other flaws present on the outer surface 21 and the inner surface 22 of tube 20-1. Probe 10 can be moved to any of the tubes (e.g., 20-2, 20-3, etc.) in a water wall boiler panel assembly.

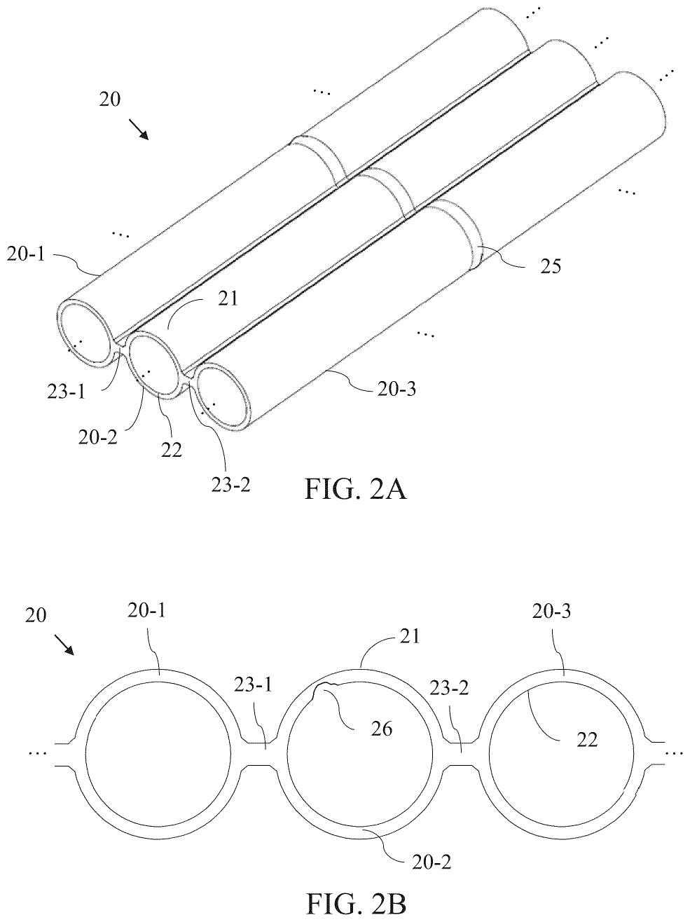

FIG. 2A illustrates one example of a typical configuration of a water wall boiler panel 20 comprised of tubes 20-1, 20-2, 20-3 and welds 23-1, 23-2 connecting each of said tubes 20-1, 20-2, 20-3 along their lengths, which may or may not include a membrane bar. These tubes 20-1, 20-2, 20-3 may extend well beyond the portion illustrated in FIG. 1 and FIGS. 2A and 2B, both in terms of the quantity of tubes 20-1, 20-2, 20-3, etc. and their respective lengths. At some locations along the length of a tube, a girth weld 25 may also be present.

FIG. 2B illustrates a cross-sectional view of the water wall boiler panel 20 showing the membrane welds 23-1, 23-2 and wall loss 26 due to corrosion on the inner surface 22 of one of the tubes.

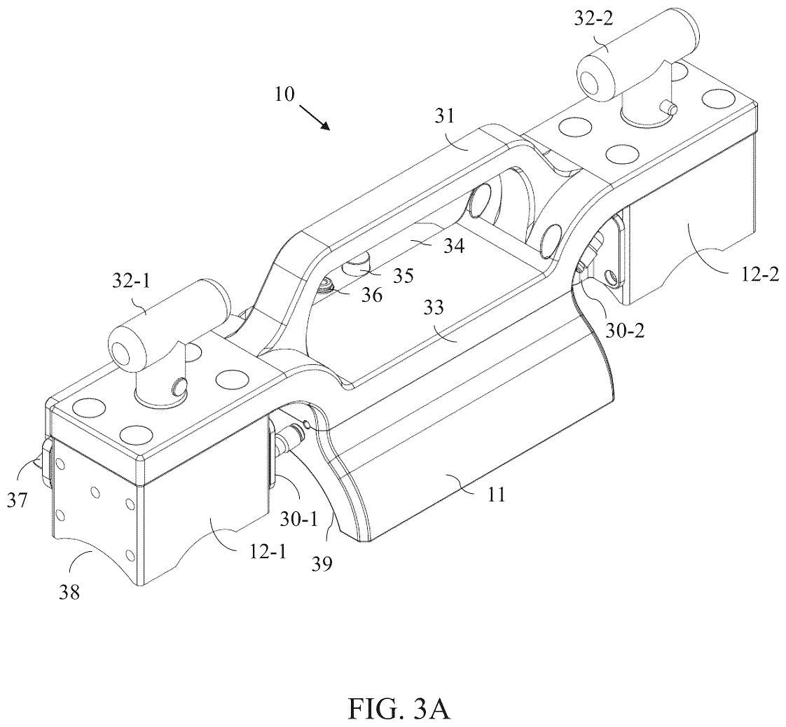

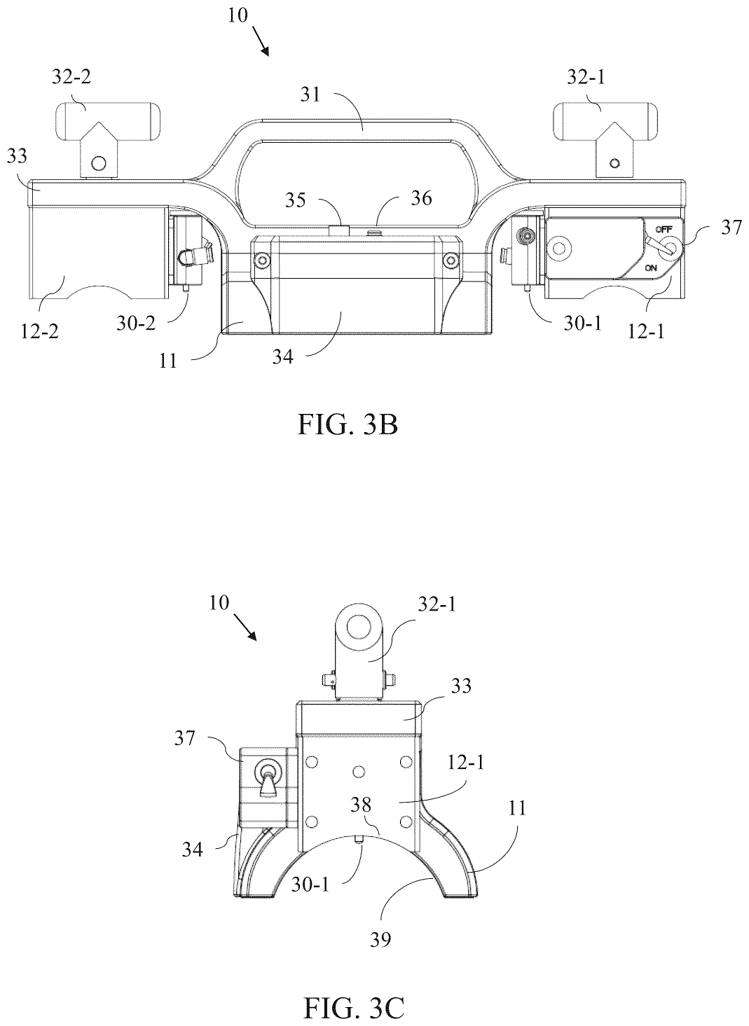

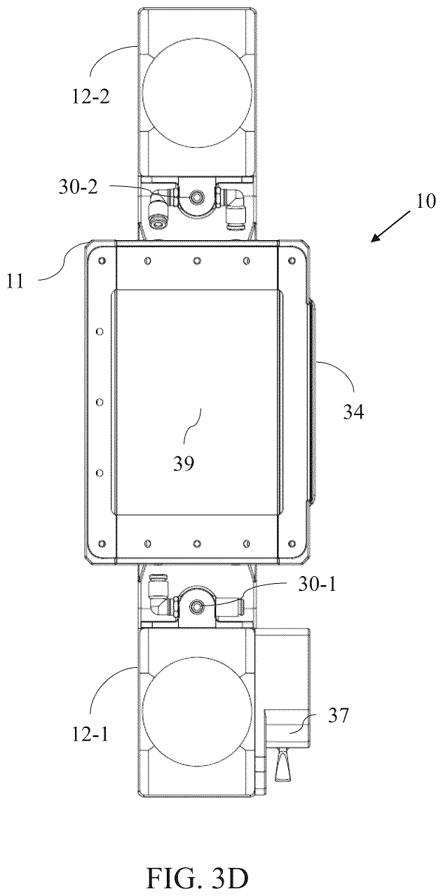

FIGS. 3A-3D provide more detailed views of one example of a probe 10 in accordance with some embodiments. Probe 10 may include a probe shoe 11 having a shoe face 39 configured to be in contact with an outer surface of a tube, at least one retention magnet 12-1, 12-2 with a curvature 38 designed to at least partially conform to the curvature of said tube surface, and a rigid probe body 33 to which said probe shoe face 39 (FIG. 3C) and retention magnets 12-1, 12-2 (FIG. 3B) may be connected. In some embodiments, probe 10 may include a handle 31, magnet switch knobs 32-1 and 32-2, at least one pressure relief valve 30-1, 30-2, an air hose connector 36, a signal connector 35, a connector cover 34, and a pressure coupling switch 37.

Probe 10 may be configured to generate guided waves 13 in a tube by means of a magnetostrictive sensor assembly within sensor shoe 11. Ultrasonic coupling may be achieved between sensor shoe face 39 and an outer tube surface 21 by means of mechanical pressure coupling, which may be generated by means of pneumatic pressure from within shoe 11. The coupling force may be counteracted by magnetic forces generated between the at least one retention magnet 12 and tube 20; these forces may be transferred through probe body 33. In some embodiments, the at least one retention magnet 12-1, 12-2 may be of the permanent-switchable type such as those marketed under the “Magswitch” brand name by Magswitch Technology of Superior, Colorado. In some embodiments, magnets 12-1, 12-2 may be of the electromagnetic type. The ability to engage/disengage said retention magnets 12-1, 12-2 may advantageously enable moving the probe 10 between tubes. In some embodiments, retention magnets 12-1 and 12-2 may be engaged/disengaged by manually rotating magnet switch knobs 32-1 and 32-2, respectively. In some embodiments, rotation of said switch knobs may be facilitated by automated means including, but not limited to, pneumatic rotary switches, servo motors, and other mechanisms as will be understood by those of ordinary skill in the art.

In some embodiments, probe 10 may comprise at least one pressure relief valve 30, which may be configured to reduce the air pressure if the probe is not sufficiently retained against an outer tube surface 21 and which could lead to probe damage or a safety hazard for the user. In some embodiments, the pressure relief valves 30 may be of a cartridge valve type, in which a spring-loaded plunger may be forced to retract due to contact with outer tube surface 21, thereby allowing flow through the valve. If said plunger is not depressed, the air pressure is vented from the system. One example of a suitable cartridge valve type pressure relief valve is the MAV-3C cartridge valve available from Clippard of Cincinnati, OH. It should be understood that other types of valves may be suitable. The use of at least one pressure relief valve 30 may prevent probe shoe pressurization if the probe is not connected to a tube or if the retention magnetic force is insufficient to overcome the pressure coupling force and the probe begins to separate from an outer tube surface 21. In some embodiments, a manual switch 37 further controls the pressurization of the probe shoe.

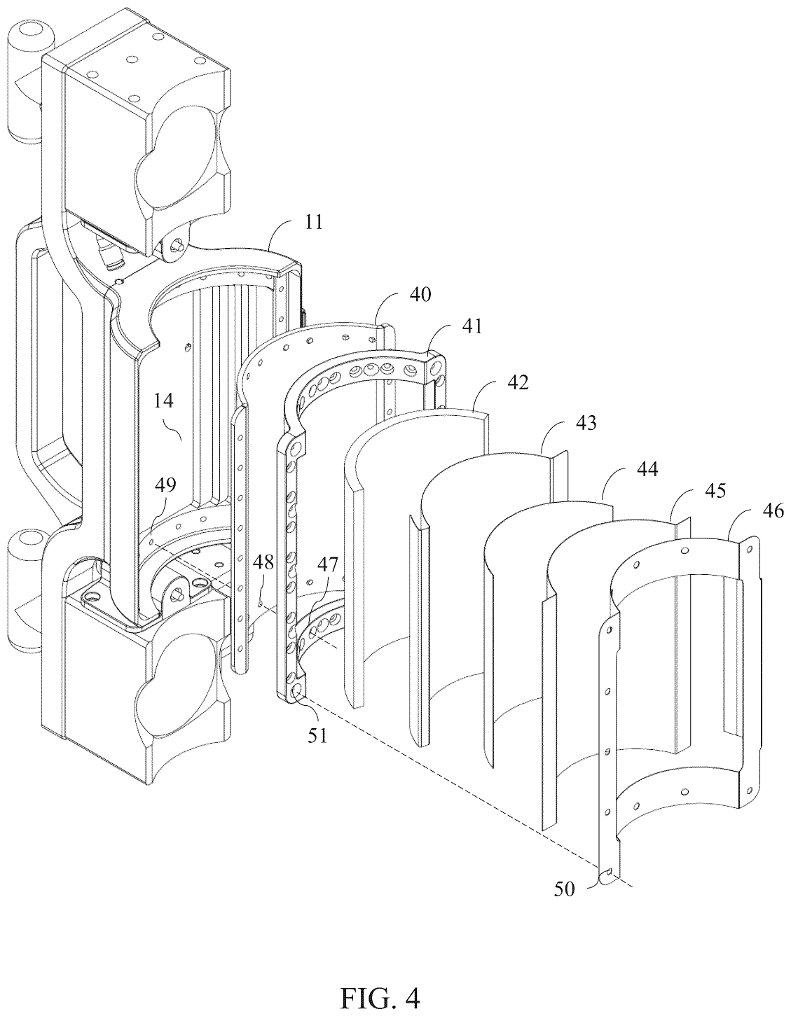

Connector cover 34 may be designed to cover and protect signal connector 35 and the electrical joint between said connector and sensor coil 43, which is shown in FIG. 4. The connector cover 34 may also serves to protect an air connection 36. In some embodiments, a portion of outer layer 46 may extend under cover 34 to provide additional protection of sensor coil 43.

FIG. 4 illustrates an exploded view of one example of a magnetostrictive sensor assembly that may be housed in a sensor shoe 11 in accordance with some embodiments. In some embodiments, mechanical pressure coupling may be achieved by pneumatically pressurizing chamber 14 in probe shoe 11. Chamber 14 may be sealed with an elastomeric pressure diaphragm 41, which may be clamped between the perimeter of chamber 14 and diaphragm flange 41 by means of fasteners passing through holes 47 in said flange and holes 48 in said diaphragm and into threaded holes 49 in probe shoe 11. A sensor mid-layer 42 is configured to be disposed against diaphragm 40 within the region defined by flange 41. In some embodiments, mid-layer component 42 is composed primarily of an elastomer including, but not limited to, silicone rubber, neoprene, polyurethane, and EPDM or a compressible heat resistant material including, but not limited to fiberglass, aramid, and aerogel-based fiber materials. Mid-layer 42 may have a thickness that is approximately equal to the thickness of flange 41, although mid-layer 42 may have other thicknesses as will be understood by one of ordinary skill in the art. Sensor coil 43 may be designed to be configured primarily on the surface of mid-layer 42 that is opposite diaphragm 40. In some embodiments, sensor coil 43 is partially wrapped around at least one edge of mid-layer 42 in order to secure it in place. Ferromagnetic material 44 may be disposed on the surface of sensor coil 43 opposite mid-layer 42, and coupling layer 45 may be disposed on the surface of ferromagnetic material 44 opposite sensor coil 43. Finally, an outer layer 46 may be configured to partially overlap the edges of components 42, 43, 44, and 45 such as to retain them within the region defined by diaphragm flange 41. Outer layer 46 is designed to be attached to flange 41 by means of fasteners passing through holes 50 in said outer layer and threaded holes 51 in said flange. Outer layer 46 may be formed from a variety of materials. In some embodiments, the outer jacket component 46 may be primarily composed of a material more rigid than that of the mid-layer component 42, including, but not limited to, stainless steel

Pneumatic pressurization of cavity 14 may lead to deformation of diaphragm 40, which transfers the pressurization force to mid-layer 42 and consequently through layers 43, 44, and 45. When probe shoe 11 is disposed on a tube (e.g., tube 20-1, 20-2, 20-3, etc.) such that probe shoe face 39 is configured adjacent to outer tube surface 21, said pressurization force may be transferred to surface 21. This may facilitate a mechanical pressure coupling between ferromagnetic strip 44 and tube surface 21 via coupling layer 45, which, in some embodiments, is comprised of an aluminum alloy.

In some embodiments, the pneumatic pressure required to achieve acceptable coupling may be between 30 and 80 psi. However, it should be understood that other pneumatic pressures may be suitable.

In some embodiments, diaphragm 40 may be a self-contained air bladder.

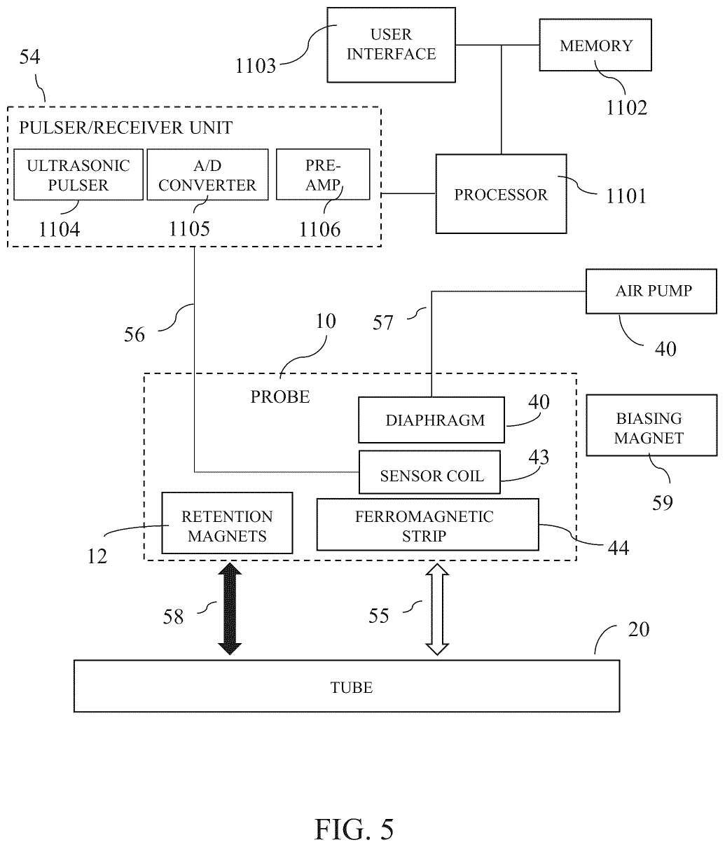

FIG. 5 provides a block diagram of one example of a system in accordance with some embodiments. The system may include a processor 1101 in signal communication with a signal generator/receiver 1100, a memory 1102, and a user interface 1103. User interface 1103 can be implemented using multiple components, including a display, a keyboard, and/or a mouse. In some embodiments, user interface 1103 is implemented as touch screen display. A person of ordinary skill in the art will understand that a variety of other user interfaces 1103 can be used.

In some embodiments, memory 1102 may include at least one of a read only memory (ROM), random access memory (RAM), a flash memory, or other non-transitory machine-readable storage medium. Memory 1102 may be configured to store software that when executed by processor 1101 controls signal generator/receiver 1100 and performs signal processing techniques to generate and subsequently enhance at least one inspection signal plot. The signal processing techniques utilized in the software may include, but are not limited to, at least one of averaging, filtering, directional wave control, and multi-frequency data acquisition.

In some embodiments, the signal generator/receiver 54 may include at least an ultrasonic tone-burst pulser 1104, an analog-to-digital converter 1105, and a pre-amplifier 1106. The processor 1101 and signal generator/receiver 54 may be configured to cause a pulse to be generated by the at least one sensor coil 43, process the reflected signals detected by the at least one sensor coil 43, and record the waveform information in the machine-readable storage medium 1102.

In some embodiments, in addition to the pulser/receiver unit 54, the system may include a controller and a graphic user interface 1103. The controller may include a machine-readable storage medium, e.g., memory 1102, and a processor 1101 in signal communication with said machine-readable storage medium. The processor may be configured to cause a pulse to be generated by the at least one sending magnetostrictive sensor coil 43, measure the reflected signals detected by the at least one receiver magnetostrictive sensor coil 43, and save the waveform data in the machine-readable storage medium. In some embodiments, the pulser and receiver sensor coils may be the same sensor coil, although a pulser coil and a separate receiver coil may be provided.

Pulser-receiver unit 54 may be in signal communication with sensor coil 43 in probe 10 via signal cable 56. Air pump 40 may be connected to the pressure diaphragm system 40 in probe 10 via air hose 57. Sensor coil 43 may be positioned between diaphragm 40 and ferromagnetic material 44, which may have a strip shape (e.g., a length equal to or longer than a width) and be disposed adjacent to a tube 20-1, 20-20-3, etc. Mechanical pressure coupling 55 may be achieved by means of pressure applied by diaphragm 40 onto ferromagnetic material 44 and a tube 20-1, 20-2, 20-3, etc., which facilitates efficient ultrasonic energy transfer between said ferromagnetic material 44 and said tube 20-1, 20-2, 20-3. Force balance may be achieved by the magnetic retention force 58 generated between probe 10 and a tube 20-1, 20-2, 20-3, etc., by means of the at least one retention magnet 12-1, 12-2.

Various embodiments of the system pulser/receiver electronics can be used to accomplish the means of generating guided waves and receiving guided wave reflections in the tube. In some embodiments, the system pulser/receiver electronics comprise at least one ultrasonic tone-burst or square wave pulse generator, at least one analog-to-digital converter, at least one pre-amplifier, and at least one of phased array and multiplexing circuitry to facilitate generating guided waves from at least one pulser coil and to facilitate receiving guided wave signals from at least one receiver coil.

By at least one of sending and receiving guided wave signals via at least two independent pulser coils separated by a known distance parallel to the axis of the pipe and two independent receiver coils separated by a known distance parallel to the axis of the pipe, directional wave control can be implemented by means of at least one of real-time time delays between said parallel coils using phased array hardware and artificial time delays between said parallel coils applied in post processing.

Referring again to FIG. 1, the system may generate guided waves 13 via the magnetostrictive effect, by which a time-varying strain is induced in a magnetostrictive material 44 by means of generating a time-varying current in the probe sensor coil 43 in the presence of a biasing magnetization, said biasing magnetization being perpendicular to the direction of wave propagation 24. The coil traces may be oriented in a manner such that they induce a time-varying magnetic field in the ferromagnetic material 44 that is parallel to the wave propagation direction 24. By this process, shear horizontal-type guided waves 13 are generated in tube 20 to which the ferromagnetic material 44 is coupled. The shear horizontal-type guided waves 13 propagate through the structure 20 away from probe 10, and reflected wave energy from any structural anomalies is subsequently detected by the sensor coil 43 via the inverse magnetostrictive effect. The ferromagnetic material 44 can comprise any suitable material, such as nickel or an iron-cobalt alloy.

In some embodiments, the disclosed system generates and detects guided wave modes in the T(n,1) family and/or SH-type waves. The system may be switched between generating and receiving torsional/SH-type modes and longitudinal/Lamb-type modes by reorienting the biasing magnets in the system; this process is well-known to those of ordinary skill in the art. In some inspection scenarios, one type of guided wave mode may feature advantages over the other, and thus the ability to rapidly select and adjust the system for either type of guided wave mode excitation is advantageous.

The at least one pulser and receiver coils 43 may be a flat-flexible cable or a flexible printed circuit board and may be interchangeable to generate and receive guided waves across a wide range of frequencies between 10 kHz and 2 MHz, for example.

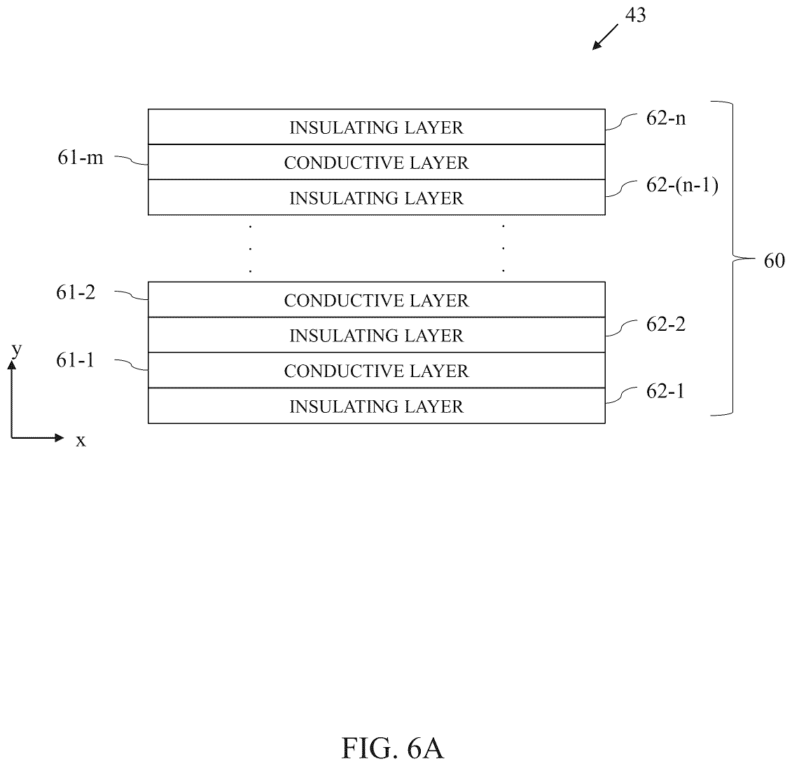

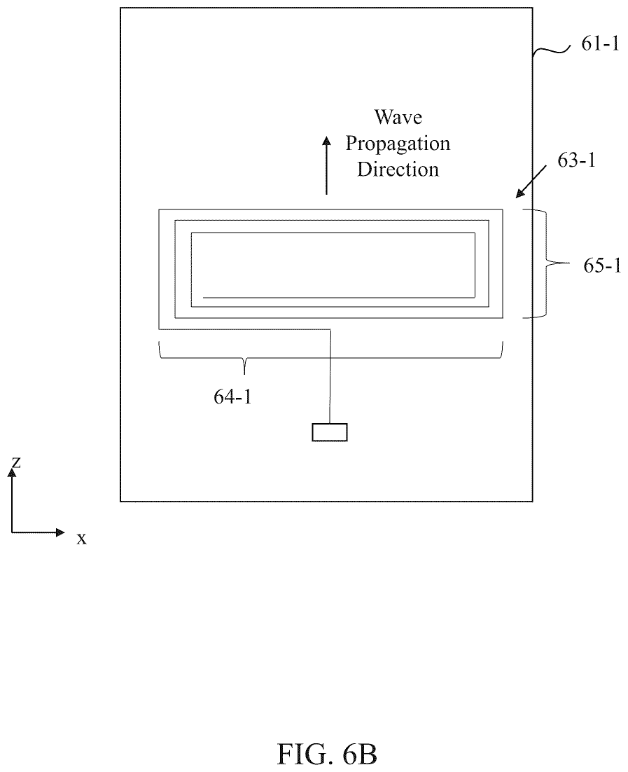

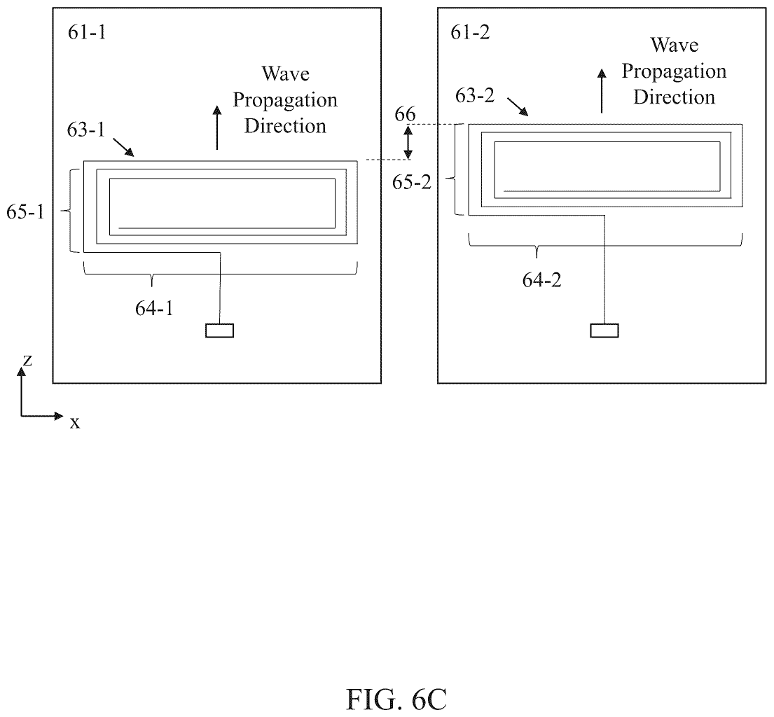

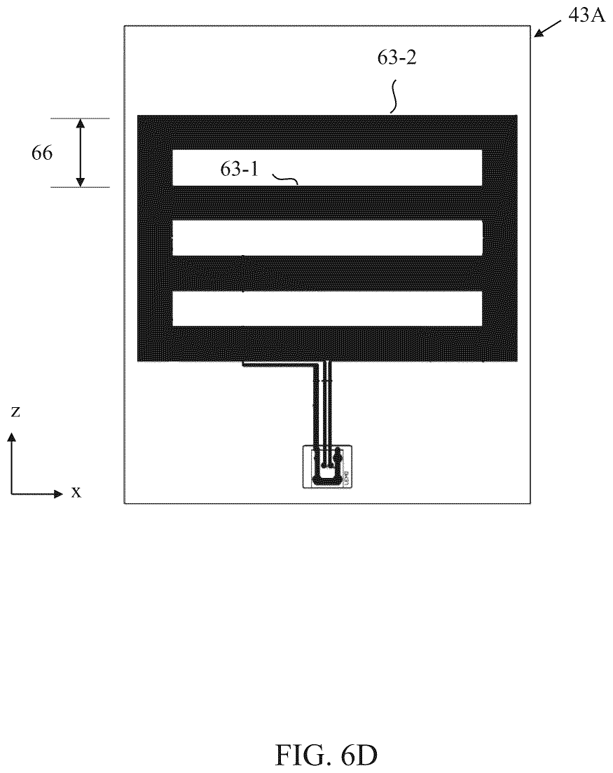

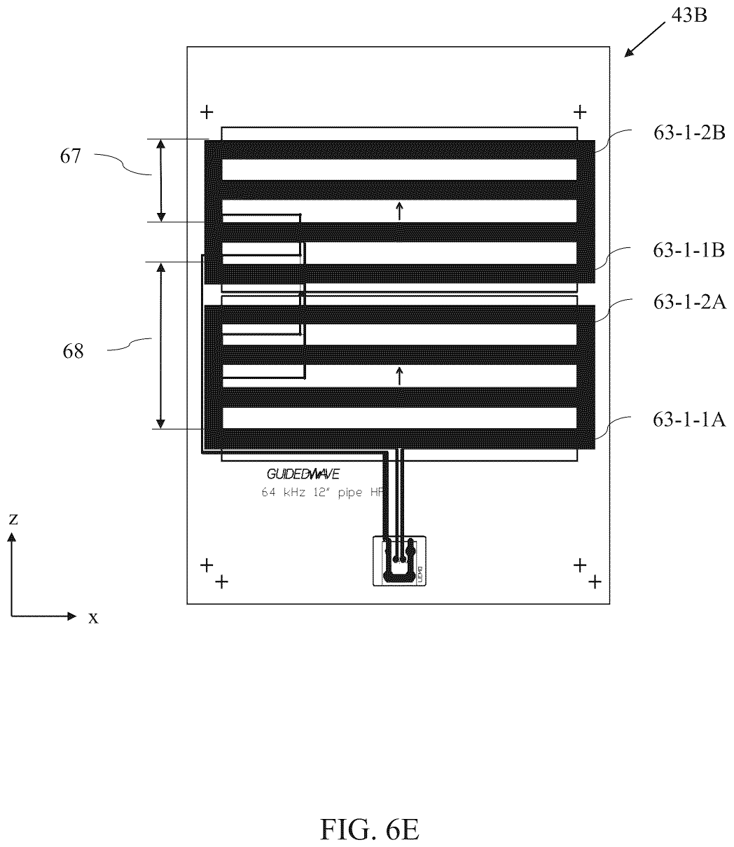

One example of a magnetostrictive pulser/receiver sensor coil circuit 43 is illustrated in FIGS. 6A-6E. FIG. 6A is a cross-sectional view of one example of a pulser/receiver coil circuit 43 formed in a printed circuit board 60, which includes a plurality of insulating layers 62-1, 62-2, . . . , 62-n (“insulating layers 62”) and a plurality of conductive layers 61-1, 61-2, . . . , 61-m (“conductive layers 61”) stacked in the y-direction in an alternating manner. Insulating layers 62 and conductive layers 61 form a printed circuit board (“PCB”). In some embodiments, the PCB is a flexible PCB and insulating layers 62 are formed from a polyimide, silicone, or other flexible insulating material, and conductive layers 61 are formed from copper or another conductive material.

Each conductive layer 61 may include one or more coils 63 (comprising a loop of conductive material, such as copper as shown in FIGS. 6B-6E) for producing a dynamic magnetic field in the magnetostrictive/ferromagnetic material in response to signals received from controller 54.

FIG. 6B illustrates one example of a plan view of a first coil 63-1 formed in a single conductive layer, e.g., conductive layer 61-1 of a multi-layer circuit board 60. Coil 63-1 may include a number of closely spaced narrow traces that are arranged in a spiral configuration such that the overall coil 63-1 may have a generally rectangular shape as illustrated in FIG. 6B. Coil 63-1 may be configured to generate a wave that propagates in the z-direction with the coil 63-1 having an active area 64-1 along its length that extends perpendicular to a direction in which the generated wave propagates (e.g., in the x-direction). The portions of coil 63-1 that extend parallel to the direction of propagation of the propagating waves, i.e., those portions of coil 63-1 that extend parallel to the z-direction, may be referred to as the ineffective area 65-1 of coil 63-1.

As noted above, each conductive layer 61 of the multi-layer circuit board 60 may include a respective coil 63. The coils 63 formed in the different conductive layers 61 may be offset from one another in the z-direction. For example, FIG. 6C is a plan view of a first coil, e.g., coil 63-1, formed in a first conductive layer, e.g., conductive layer 61-1, disposed adjacent to a second coil, e.g., coil 63-2, formed in a second conductive layer, e.g., conductive layer 61-2. FIG. 6D is a plan view of the circuit 43A illustrated in FIG. 6C where the coils 63-1, 63-2 are simplified and shown as large, solid lines. As shown in FIGS. 6C and 6D, coil 63-1 in the first conductive layer 61-1 may be offset in the z-direction relative to coil 63-2 formed in the second conductive layer 61-2 (or vice versa) as indicated by reference numeral 66. The coils 63-1, 63-2 in the different conductive layers 61-1, 61-2 may be conductively isolated from one another by an intervening insulating layer, such as insulating layer 62-2 shown in FIG. 6A. Offsetting the active areas 64-1, 64-2 of coils 63-1, 63-2 enables a wave to be generated in a single direction (e.g., towards the bottom of the page in FIGS. 6C and 6D) as the wave propagating in the opposite direction (e.g., towards the top of the page in FIGS. 6C and 6D) is canceled (through destructive interference) due to the offset and the manner in which the control signals received from pulser/receiver unit (e.g., a controller) 54 actuate coils 63-1, 63-2 as will be understood by those of ordinary skill in the art.

As described above, the number of conductive layers 61 that include coil(s) 63 may be varied. For example, FIG. 6E illustrates an example of a coil circuit 43B that is comprised of two subsets of coils 63, denoted by the letters “A” and “B” for the first and second coil subsets, respectively. The coil segments 63-1-1A and 63-1-2A are offset in the z-direction from their respective pairs 63-1-1B and 63-1-2B, respectively be a distance denoted by reference numeral 68. Note that the addition of multiple subsets of coils can be advantageous in increasing the signal amplitude and sensitivity of the sensor system. The offset in the z-direction of the upper and lower active areas of coil 63-1-2B is denoted by reference numeral 67 and is common for all individual coil segments. The offset 67 is equal to ½ the offset denoted by 68. Furthermore, the offset 66 denoted in FIG. 6C is equal to ¼ of offset 68. Referring again to FIG. 6E, a magnetostrictive coil 43 (e.g., coil circuits 43A, 43B) may most effectively generate and receive guided waves with a wavelength equal to 68 in this configuration; thus, the center of the wavelength spectrum of the guided waves generated by said coil circuit 43B can be controlled by adjusting offsets 68, 67, and 66 accordingly. A person of ordinary skill in the art will understand that said wavelength spectrum can be converted into an equivalent frequency spectrum for excitation of a guided wave mode with a known phase velocity.

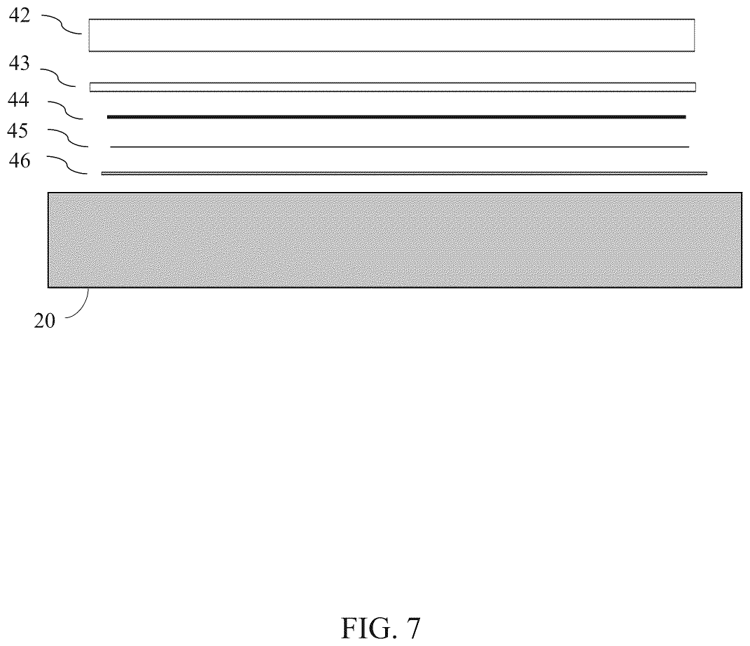

FIG. 7 illustrates one embodiment of the composition of the sensor assembly in shoe 11, which is similar to, but not identical to, that disclosed in U.S. Pat. No. 11,460,441, the entirety of which is incorporated herein by reference. Ferromagnetic material 44 may be configured such that at least some portion of it is in direct contact with a surface of test object (e.g., a tube 20-1, 20-2, 20-3, etc.) or in direct contact with coupling material 45, which may also be in direct contact with the test object. A sensor coil 43 may be disposed in close proximity to ferromagnetic material 44 and a mid-layer 42 is disposed above said sensor coil 43. In some embodiments, the sensor coil 43 may be disposed 1 mm or less away from the ferromagnetic material 44, although the sensor coil 43 may be disposed at other distances from the ferromagnetic material 44. Furthermore, an outer jacket 46 may be disposed at least partially below ferromagnetic strip 44 and coupling material 45 and above test object (e.g., a tube 20-1, 20-2, 20-3, etc.).

In some embodiments, at least one thin coupling layer 46 is a layer of aluminum (or other metal) foil between magnetostrictive material 44 and test object 20 for the purpose of improving ultrasonic coupling.

What is claimed is:

1. A system, comprising:
a probe, the probe including:
a shoe configured to be coupled to an object to be tested;
at least one retention magnet supported by a body of the probe and configured to couple the probe to the object; and
at least one magnetostrictive sensor assembly supported by the shoe of the probe; and
a pulser/receiver unit configured to be communicatively coupled to the at least one magnetostrictive sensor assembly, the pulser/receiver unit configured to cause at least one ultrasonic guided wave into the object via the at least one magnetostrictive sensor assembly and to receive a reflection of the at least one ultrasonic guided wave via the at least one magnetostrictive sensor assembly.

2. The system of claim 1, wherein the at least one retention magnet includes a permanent-switchable type magnet.

3. The system of claim 2, wherein the probe includes at least one switch knob coupled to the at least one retention magnet for selectively engaging the at least one retention magnet.

4. The system of claim 1, wherein the shoe includes a mechanical pressure coupling configured to couple the at least one magnetostrictive sensor assembly to the surface of the object.

5. The system of claim 4, wherein the magnetic pressure coupling includes a chamber defined by the shoe configured to be pneumatically pressurized.

6. The system of claim 5, wherein an elastomeric pressure diaphragm is at least partially disposed within the chamber defined by the shoe.

7. The system of claim 6, wherein the probe includes at least one pressure relief valve configured to prevent pressurization of the chamber.

8. The system of claim 1, wherein a surface of the at least one retention magnet is curved to facilitate coupling of the probe to a curved surface of the object.

9. A system for non-destructively testing an object, the system comprising:
a probe, including:
a body including a shoe;
at least one magnetostrictive sensor assembly supported by the shoe;
at least one coupling device of a first type supported by the body, the at least one coupling device of the first type configured to provide a first force for coupling the probe to the object; and
at least one coupling device of a second type supported by the body, the at least one coupling device of the second type configured to provide a second force for coupling the at least one magnetostrictive sensor assembly to the object.

10. The system of claim 9, wherein the at least one coupling device of the first type includes a magnet supported by the body of the probe.

11. The system of claim 10, wherein the at least one coupling device of the second type includes an elastomeric pressure diaphragm that is at least partially disposed within a chamber defined by the shoe.

12. The system of claim 11, wherein the probe includes at least one pressure relief valve configured to prevent pressurization of the elastomeric pressure diaphragm.

13. The system of claim 12, wherein:
the elastomeric pressure diaphragm is disposed within the chamber defined by the shoe and at least partially sealed with a coupling layer, and
the at least one magnetostrictive sensor assembly is disposed between the elastomeric pressure diaphragm and the coupling layer.

14. The system of claim 13, wherein the at least one magnetostrictive sensor assembly includes:
a strip of ferromagnetic material disposed adjacent to the coupling layer; and
at least one sensor coil disposed between the elastomeric pressure diaphragm and the strip of ferromagnetic material.

15. The system of claim 14, wherein the coupling layer is curved.

16. The system of claim 15, wherein an outer jacket is coupled to the shoe and at least partially overlaps the coupling layer.

17. The system of claim 9, wherein the at least one coupling device of the first type includes:
a first magnet disposed on a first side of a handle of the body of the probe; and
a second magnet disposed on a second side of the handle of the body of the probe.

18. The system of claim 14, wherein the probe includes at least one switch knob for selectively providing the first force.

19. The system of claim 9, wherein the at least one coupling device of the second type includes an elastomeric pressure diaphragm that is at least partially disposed within a chamber defined by the shoe.

20. The system of claim 9, further comprising a pulser/receiver unit configured to be communicatively coupled to the at least one magnetostrictive sensor assembly, the pulser/receiver unit configured to cause at least one ultrasonic guided wave into the test object via the at least one magnetostrictive sensor assembly and to receive a reflection of the at least one ultrasonic guided wave via the at least one magnetostrictive sensor assembly.
